(19) United States
(12) Patent Application Publication
(10) Pub. No.: US 2026/0253064 A1
(43) Pub. Date: Aug. 27, 2026

(54) METHOD FOR THE DEPERSONALIZATION AND TRANSMITTAL OF FINANCIAL INFORMATION FOR FINANACIAL TRANSACTIONS

(71) Applicant: Fluid Financial, Madison, NJ (US)

(72) Inventor: Jonathan Lee, Boca Raton, FL (US)

(21) Appl. No.: 19/176,129

(22) Filed: Apr. 10, 2025

Related U.S. Application Data
(63) Continuation-in-part of application No. 19/061,869, filed on Feb. 24, 2025.

(51) Int. Cl. G06Q 20/38; G06Q 20/20; G06Q 20/40

(52) U.S. Cl. CPC G06Q 20/3823; G06Q 20/206; G06Q 20/3825; G06Q 20/389; G06Q 20/4014

(57) ABSTRACT

A method of facilitating payment for goods and services, having steps including the generation of transaction tokens containing only information necessary for the payment of a vendor, but not including unnecessary data, such as personal sensitive data. Currently there is a problem in the system wherein private, confidential, or sensitive information is transmitted and stored as a part of processing credit card or other electronic payments in connection with a purchase and then this information is sold, potentially creating liability for vendors. This method prevents this by ensuring that the sensitive data is never transmitted to financial services vendors, and so is not in danger of disclosure.

### CROSS-REFERENCE TO RELATED PATENT APPLICATIONS

The present application is a continuation-in-part of U.S. application Ser. No. 19/061,869 filed on Feb. 24, 2025, entitled “A METHOD FOR THE DEPERSONALIZATION AND TRANSMITTAL OF FINANCIAL INFORMATION OF PATIENTS.”

### BACKGROUND OF THE INVENTION

### 1. Field of the Invention

Embodiments of the invention relate generally to health care transactions and the payment for the same via electronically communicated methods, including but not limited to credit card payments, and more particularly towards methods of ensuring appropriate security of protected health information.

Further embodiments of this invention relate generally to electronic purchases utilizing credit cards, debit cards, and other payment methods that involve the transmission of transaction data to financial institutions.

### 2. Description of Related Art

The health care industry is ubiquitous in today's economy, whether it is traditional care found in hospitals or primary care settings, new forms of health care such as telemedicine, or even aesthetic care such as “med-spas.” With any such widespread industry, it follows that payment for services must be dealt with in an expedient and efficient manner. Thankfully, the global economy has a ready-made solution-credit cards and other electronically communicated payment methods. A patient need only swipe their card, and the care is paid for. This system is relatively robust and well tested; indeed, the system works for nearly every aspect of the global economy and credit cards issued by major vendors are accepted at almost every vendor. One particular feature of this system is its ease-of-use-a consumer need only swipe a card and payment is effectuated. Of course, the technical reality behind this simplistic picture is much more complicated. In swiping the card, a packet of information is sent from the vendor at the point of sale to the financial services vendor, containing various pieces of information about the transaction. This information can include, but is not limited to, the customer's name, vendor's name, credit card number, expiration date, security code, amount of the transaction, and date and time of the transaction. This information is then utilized for a variety of purposes by the financial services vendor, including but not limited to validation of the transaction and potential security measures.

A current issue with the system as it stands is the meshing of the credit card validation process and the necessarily confidential and sensitive nature of medical treatment. In the current system, the financial services vendor receives the same information about a health care transaction as it would about any other transaction, including information that may protected by federal statute(s) such as HIPAA or simply information that a patient may not feel comfortable sharing outside the confines of the patient-health care provider relationship. The current system also poses considerable risk. Breaches in the security of credit card companies and other financial can occur, and the risk posed by such breaches is magnified when the information leaked by such breaches includes sensitive health and health care information.

The inventive concept addresses this concern by eliminating unnecessary transaction data from transactions occurring at health care providers prior to the transaction data being sent to the financial services vendor. This elimination helps make payments to health care providers more compliant with federal law and helps lessen the potential damage of any breach that may occur.

Additional embodiments of this invention are applicable to the broader financial market. The financial industry as it exists today involves the transmission of enormous quantities of data throughout the country and the world. For every purchase or transaction made with a credit card, debit card, or many other methods of payment, there is a host of data that is transmitted from the point of sale to the financial services provider. This data contains important information about the information, such as identity, vendor identity, amount of purchase, and various financial information, such as credit card number. In the current system, all this information is transmitted to a financial institution when a purchase is made, and the financial institution then issues a decision as to whether the purchase is approved or not. The transmitted data is then kept by the financial institutions and is often sold to third parties such as advertisers and other entities with a use for personal information. This information is often sold in bulk.

A current issue with the system as it stands is the potential sale of personal data to entities in such a way as might create liability for a vendor, a seller, or a financial institution. It is well established that it is prohibited to sell or transmit bulk sensitive personal data to certain countries of concern as defined by the government of the United States. Recent changes in the enforcement of this law have indicated that liability for any such transmittal may fall not only on the entity involved in the transmission, but also any entities that were involved in the creation of the personal sensitive data, such as an individual vendor. This is regardless of whether or not the vendor knew about, consented to, or was involved at all in the offending transmission. This clearly creates an increased risk of financial liability for vendors that needs addressing. The present invention provides a solution.

The inventive concept addresses this concern by eliminating unnecessary personal sensitive transaction data from transactions occurring at vendors prior to the transaction data being sent to the financial services vendor. This elimination helps make payments to vendors more compliant with federal law and helps lessen potential liability.

### SUMMARY OF THE INVENTION

The disclosed method adds security to the process of requesting and issuing payment to health care providers via electronic methods, including but not limited to credit card payments. The method comprises the obtainment of consent to utilize the process, the generation of a token at a point of sale, the transmittal of the token to a processor, the decryption of the token, the elimination of unnecessary transaction data, the generation of a new token, and the transmittal of the new token to the financial services vendor. The data to be removed from the token includes, but is not limited to, the transaction source and goods or services being purchased. Once the new token in transmitted to the financial services vendor, it is processed as normal and payment is approved or denied by the financial services vendor.

Additional embodiments may include the ability for a patient to access purchase information via an online portal.

An additional disclosed method adds security to the process of requesting and issuing payment to vendors via electronic methods, including but not limited to credit card payments. The method comprises the obtainment of consent to utilize the process, the generation of a token at a point of sale, the transmittal of the token to a processor, the decryption of the token, the elimination of unnecessary transaction data, the generation of a new token, and the transmittal of the new token to the financial services vendor. The data to be removed from the token includes, but is not limited to, the transaction source and goods or services being purchased. The data to be removed also includes data defined as personal sensitive data. Once the new token in transmitted to the financial services vendor, it is processed as normal and payment is approved or denied by the financial services vendor.

Additional embodiments may include the ability for a consumer to access purchase information via an online portal.

### BRIEF DESCRIPTION OF THE DRAWINGS

FIG. 1 is a diagram of the parts of the current system, including the flow of data through the system.

FIG. 2 is a diagram of the parts of a system that utilizes the method disclosed in this application, including the flow of data through the system.

FIG. 3 is a flowchart of the method disclosed in this application.

### DETAILED DESCRIPTION OF EMBODIMENTS

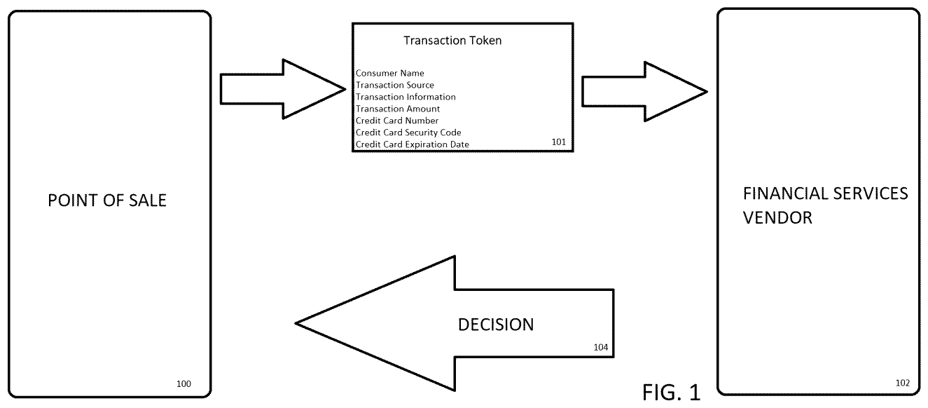

While the invention is illustrated and described in a preferred embodiment, the invention may be produced and described in many different configurations, forms, and various methods, without deviating from the scope of the present invention. The preferred embodiment of the invention is described in detail below with reference to the accompanying FIGS. 1-3, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the invention described herein.

Referring now to FIG. 1, a current method is disclosed. The current system in place for the purchase and payment for goods and services is set out in FIG. 1. A purchase is initiated at a point of sale 100, which generates a transaction token 101. This transaction token 101 contains various pieces of information related to the transaction, including, but not limited to, information such as the customer's name, the source of the transaction, information about the goods or services being purchased, the amount of the transaction, the credit card number, the credit card security code, and the expiration date of the credit card. Other pieces of information can include those defined as personal sensitive information. Once generated, the transaction token 101 is then encrypted and transmitted to the financial services vendor 102. Once the transaction token 101 is received and decrypted, the financial services vendor 102 then renders a decision 104 on whether to approve the transaction or not and communicates the decision 104 to the vendor at the point of sale 100.

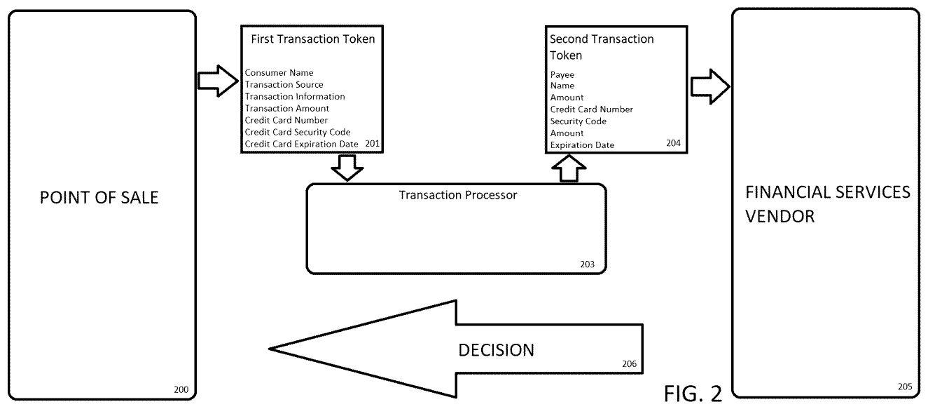

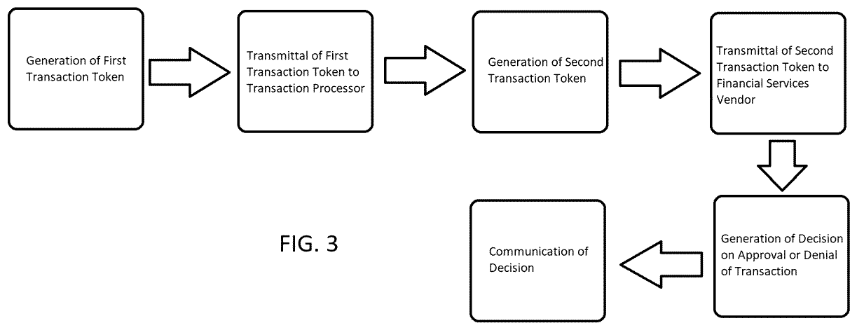

Referring now to FIGS. 2 and 3, a method is disclosed. The method is initiated when a customer consents to the use of the method. The method then continues when a good or service purchase is initiated at a point of sale 200. The point of sale 200 generates a first transaction token 201. This first transaction token 201 contains various pieces of information related to the transaction, including, but not limited to, information such as the customer's name, the source of the transaction, information about the goods or services being purchased, the amount of the transaction, the credit card number, the credit card security code, and the expiration date of the credit card. Other pieces of information can include those defined as personal sensitive information. The first transaction token 201 is then encrypted and sent to a transaction processor 203. The transaction processor 203 then decrypt the first transaction token 201, gaining access to the information within. The transaction processor 203 then creates a second transaction token 204, which contains only the information strictly necessary to process the payment, and does not contain the unnecessary information, such as the details of what the transaction was for. The second transaction token 204 is then encrypted and transmitted to a financial services vendor 205, which then utilizes the data in the second transaction token 204 to issue a decision 206 regarding the approval of the purchase. The decision 206 is then communicated directly to the vendor at the point of sale 200.

In some embodiments of the invention, the transaction processor 203 stores the gathered transaction data on a central storage medium, such as a blockchain.

Some embodiments of the invention allow a consumer to access the transaction processor 203 to retrieve data relevant to them from the central storage medium.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent particular aspects and embodiments of the invention and are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent particular aspects and embodiments of the invention and are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein.

I claim:

1. A method for the payment for goods or services from a vendor, the steps consisting of:
obtaining consent from a customer to utilize the method;
generating a first transaction token at a point of sale, wherein the first transaction token contains information about the transaction, including personal or protected information;
transmitting the first transaction token to a transaction processor;
accessing data contained within the first transaction token;
generating a second transaction token utilizing only necessary data accessed from the first transaction token;
transmitting the second transaction token to a financial services vendor for processing;
generating a decision on the approval or denial of the transaction based upon the data contained within the second transaction token; and
communicating the decision to the provider of health care.

2. The method of claim 1, wherein the first transaction token is encrypted prior to transmittal to the transaction processor.

3. The method of claim 2, wherein the first transaction token is decrypted by the transaction processor prior to the generation of the second transaction token.

4. The method of claim 1, 2, or 3, wherein the second transaction token is encrypted prior to transmittal to the financial services vendor.

5. The method of claim 4, wherein the second transaction token is decrypted by the financial services vendor prior to the generation of the decision.

6. The method of claim 1, wherein the transaction processor saves transaction information via a central storage medium.

7. The method of claim 6, wherein the central storage medium is a blockchain.

8. The method of claim 6, wherein certain data stored on the central storage medium can be accessed by a consumer utilizing a username and password.
